(19) United States
(12) Patent Application Publication
(10) Pub. No.: US 2020/0103779 A1
(43) Pub. Date: Apr. 2, 2020

(54) IMAGE FORMING METHOD, IMAGE FORMING APPARATUS, FIXING DEVICE, AND IMAGE-FORMED PRODUCT

(71) Applicant: Konica Minolta, Inc., Tokyo (JP)

(72) Inventors: Seijiro TAKAHASHI, Tokyo (JP); Kouji Sugama, Tokyo (JP); Haruo Horiguchi, Tokyo (JP); Yukiko Kusano, Toyohashi-shi (JP); Toyoko Shibata, Tokyo (JP)

(21) Appl. No.: 16/552,324

(22) Filed: Aug. 27, 2019

(30) Foreign Application Priority Data
Sep. 28, 2018 (JP) 2018-183759

(51) Int. Cl. G03G 15/01; G03G 15/08

(52) U.S. Cl. CPC G03G 15/0131; G03G 2215/025; G03G 2215/0187; G03G 15/0806

(57) ABSTRACT

An image forming method includes: developing an electrostatic latent image with a toner to form a toner image; and transferring the toner image onto a recording medium and irradiating the toner image with an actinic ray to fix the toner image to the recording medium, wherein in the transferring, a plurality of types of toner particles containing toner particles of a color toner and toner particles of a transparent toner is fixed to the same area included in the recording medium.

The entire disclosure of Japanese patent Application No. 2018-183759, filed on Sep. 28, 2018, is incorporated herein by reference in its entirety.

### BACKGROUND

### Technological Field

The present invention relates to an image forming method, an image forming apparatus, a fixing device, and an image-formed product.

### Description of the Related Art

An electrophotographic image forming apparatus applies a color toner such as yellow, cyan, magenta, or black to an electrostatic latent image formed on a photoreceptor to form a toner image, transfers the formed toner image onto a recording medium, and fixes the toner image thereto to form an image. As a method for fixing a toner image, a so-called thermal fixing method for applying heat to a toner image transferred onto a recording medium in a contact or non-contact manner to fuse the toner to the recording medium is widely used.

Meanwhile, in recent years, a so-called optical fixing method for fixing a toner image by irradiation with an actinic ray has been proposed. For example, JP 2014-191077 A describes an image forming method for transferring a toner image formed from a toner containing a compound that undergoes cis-trans isomerization and phase transition by light absorption onto a recording medium, irradiating the transferred toner image with light to soften the compound and to fuse the toner image to the recording medium, and pressing the toner image against the recording medium.

According to the optical fixing method, it is not necessary to heat a fixing member. Therefore, warm-up time (WUT) taken for the fixing member to reach a predetermined temperature can be shortened, energy for forming an image can be saved, or a corresponding medium type can be expanded to a recording medium having low heat resistance.

Meanwhile, light absorption efficiency of a color toner varies depending on a color thereof, and a light amount required for fixing also varies depending on a color thereof. Therefore, in the optical fixing method, it is difficult to emit a necessary and sufficient amount of light for color toners of all colors used for image formation disadvantageously.

Meanwhile, JP 58-102247 A describes an image forming method using a color toner containing a specific cyanine dye. JP 58-102247 A describes that fixability of a color toner of each color can be enhanced by using a color toner having infrared light absorption efficiency enhanced by inclusion of the cyanine dye.

JP 2010-128157 A describes an image forming method for irradiating a toner image transferred onto a recording medium with light having a wavelength at which absorptivity of each of a cyan toner and a magenta toner is 80% or more, and then irradiating the toner image with light having a wavelength at which absorptivity of a yellow toner is 80% or more to fix the toner image. JP 2010-128157 A describes that fixability of a color toner of each color can be enhanced by the above method.

The present inventors made intensive studies on an image forming method for fixing a toner image by an optical fixing method, and have found that fixability of a toner is low and image intensity is low in a highlight area with a small attachment amount of a color toner in a formed image disadvantageously. According to the methods described in JP 58-102247 A, JP 2010-128157 A, and the like, it is expected that an image in which any one of colors is sufficiently developed will be formed by reducing a difference in fixability among color toners of the colors. However, even by the methods described in JP 58-102247 A and JP 2010-128157 A, it is not possible to sufficiently suppress a change in fixability due to the attachment amount of a color toner.

### SUMMARY

In view of the above problems, an object of the present invention is to provide an image forming method for fixing a toner image by an optical fixing method, capable of enhancing fixability of a color toner regardless of the attachment amount of the color toner, an image forming apparatus and a fixing device for performing the image forming method, and an image-formed product formed by the image forming method.

To achieve the abovementioned object, according to an aspect of the present invention, an image forming method reflecting one aspect of the present invention comprises: developing an electrostatic latent image with a toner to form a toner image; and transferring the toner image onto a recording medium and irradiating the toner image with an actinic ray to fix the toner image to the recording medium, wherein in the transferring, a plurality of types of toner particles containing toner particles of a color toner and toner particles of a transparent toner is fixed to the same area included in the recording medium.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1A is a schematic view illustrating a state immediately after a color toner is transferred onto a recording medium when the application amount of the color toner is large;

FIG. 1B is a schematic view illustrating a state after the color toner is fixed to the recording medium when the application amount of the color toner is large, in a case where an image is formed on the recording medium using the color toner;

FIG. 2A is a schematic view illustrating a state immediately after a color toner is transferred onto a recording medium when the application amount of the color toner is small;

FIG. 2B is a schematic view illustrating a state after the color toner is fixed to the recording medium when the application amount of the color toner is small, in a case where an image is formed on the recording medium using the color toner;

FIG. 3A is a schematic view illustrating a state immediately after a color toner is transferred onto a recording medium when the application amount of the color toner is large;

FIG. 3B is a schematic view illustrating a state after the color toner is fixed to the recording medium when the application amount of the color toner is large, in a case where an image is formed on the recording medium using the color toner and a transparent toner;

FIG. 4A is a schematic view illustrating a state immediately after a color toner is transferred onto a recording medium when the application amount of the color toner is small;

FIG. 4B is a schematic view illustrating a state after the color toner is fixed to the recording medium when the application amount of the color toner is small, in a case where an image is formed on the recording medium using the color toner and a transparent toner; and

FIG. 5 is a view illustrating a configuration of an image forming apparatus according to an embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

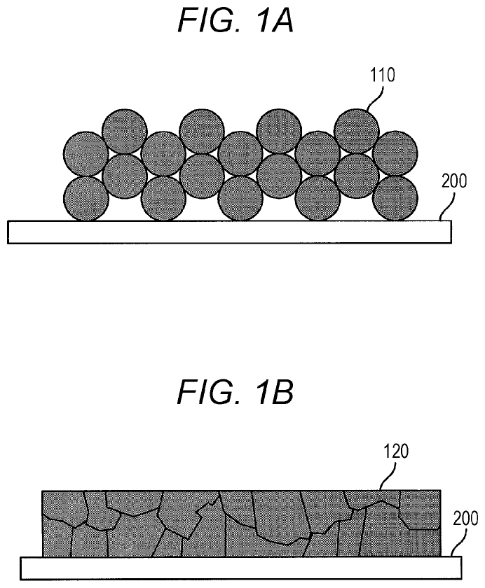

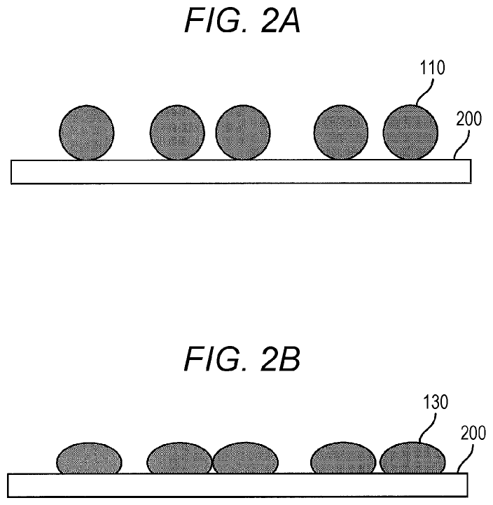

FIGS. 1A, 1B, 2A, and 2B are schematic views illustrating how an image is formed on a recording medium using a color toner. FIGS. 1A and 1B are schematic views illustrating states when the application amount of a color toner is large, and FIGS. 2A and 2B are schematic views illustrating states when the application amount of the color toner is small. FIGS. 1A and 2A are schematic views illustrating states immediately after a color toner is transferred onto a recording medium, and FIGS. 1B and 2B are schematic views illustrating states after the color toner is fixed to the recording medium.

Note that here, a toner particle means a single particle constituting a toner, and a toner means an aggregate of a sufficient amount of toner particles for forming an image, an optionally added carrier, and the like.

As illustrated in FIGS. 1A and 1B, when the application amount of a color toner is large, many toner particles 110 of the color toner are closely transferred onto a recording medium 200, and at the time of fixing, the plurality of toner particles 110 are united. In the toner particles 110 that have been closely transferred onto the recording medium 200 in this way, heat generated by light irradiation is easily conducted between the plurality of toner particles that are in close contact with each other. Therefore, viscosity of each of the toner particles is easily reduced by conduction of the heat. Therefore, each of the toner particles 110 that have been closely transferred is easily fused to the recording medium 200 by the heat, and is easily fixed to the recording medium 200 more firmly. The color toner fixed in this way is united with an adjacent color toner and fixed to the recording medium. Note that, at the time of fixing, usually, a color toner is pressed against the recording medium 200 with a roller or the like. Therefore, a surface 120 of the color toner, formed by unification and fixation, tends to be flat as illustrated in FIG. 1B.

Meanwhile, as illustrated in FIGS. 2A and 2B, when the application amount of a color toner is small, a small number of the toner particles 110 are sparsely transferred onto the recording medium 200. At this time, unlike the case where the application amount of the color toner is large, heat generated by light irradiation is unlikely to be conducted between a plurality of toner particles. Therefore, viscosity of each of the toner particles is unlikely to be reduced. Therefore, each of the toner particles 110 that have been sparsely transferred is relatively unlikely to be fixed to the recording medium 200 so firmly. Note that at this time, color toners 130 which have been fixed without being united are sparsely disposed in a formed image.

Note that it is also considered that viscosity of each of the toner particles can be sufficiently reduced by increasing the amount of light energy to be emitted at the time of fixing even when the application amount of a color toner is small. However, usually, in a formed image, an area (such as a solid portion) in which the attachment amount of a color toner is larger and an area (such as a highlight portion) in which the attachment amount of the color toner is smaller exist. If the amount of light energy to be emitted is increased according to the application amount of the color toner in the highlight portion, the viscosity of the toner particles in the solid portion is excessively reduced. When the recording medium is paper or the like, the toner particles penetrate fibers, and unevenness easily occurs in a formed image.

Therefore, in a conventional image forming method, with the amount of light energy for securing image quality of a solid portion, the fixability of a color toner in a highlight portion is unlikely to be enhanced, and a sufficient amount of the color toner is not fixed in the highlight portion to reduce the image intensity disadvantageously.

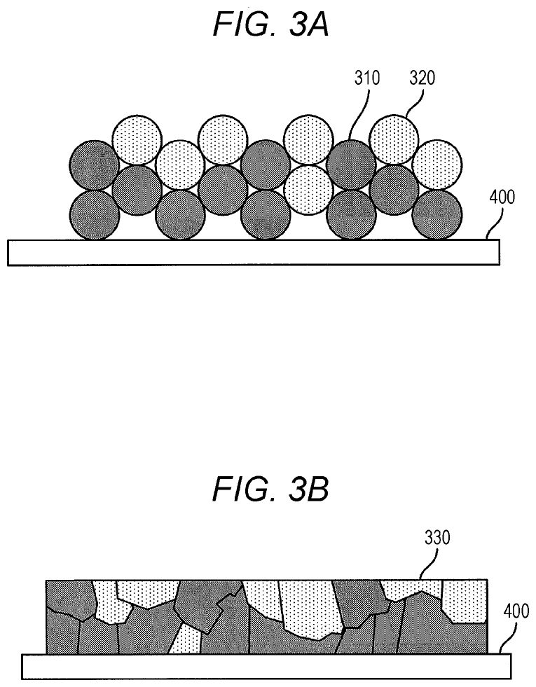

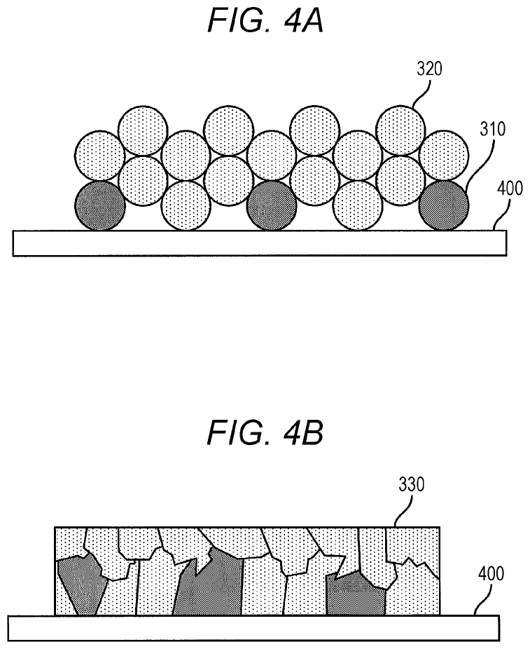

Meanwhile, in an embodiment of the present invention, a color toner and a transparent toner are used to form an image. FIGS. 3A, 3B, 4A, and 4B are schematic views illustrating how an image is formed on a recording medium 400 using a color toner and a transparent toner. FIGS. 3A and 3B are schematic views illustrating states when the application amount of a color toner is large, and FIGS. 4A and 4B are schematic views illustrating states when the application amount of the color toner is small. FIGS. 3A and 4A are schematic views illustrating states immediately after a color toner and a transparent toner are transferred onto the recording medium 400, and FIGS. 3B and 4B are schematic views illustrating states after the color toner and the transparent toner are fixed to the recording medium 400.

As illustrated in FIGS. 3A and 4A, toner particles 310 of the color toner are closely transferred onto the recording medium 400 via toner particles 320 of the transparent toner, and at the time of fixing, the plurality of toner particles 310 of the color toner is united via the toner particles 320 of the transparent toner. In the toner particles 310 of the color toner and the toner particles 320 of the transparent toner that have been closely transferred onto the recording medium 400 in this way, heat generated by light irradiation is easily conducted between the plurality of toner particles that are in close contact with each other. Therefore, viscosity of each of the toner particles is easily reduced by conduction of the heat, and each of the toner particles is easily fixed to the recording medium 400 more firmly. The color toner fixed in this way is united with another color toner via the transparent toner and fixed to the recording medium. Note that, at the time of fixing, usually, a color toner and a transparent toner are pressed against the recording medium 400 with a roller or the like. Therefore, a surface 330 of the color toner and the transparent toner, formed by unification and fixation, tends to be flat as illustrated in FIGS. 3B and 4B.

Note that the amount of light energy to be emitted at this time only needs to sufficiently reduce the viscosity of both the toner particles 310 of the color toner and the toner particles 320 of the transparent toner, and only needs to be about the same as the amount of light energy for securing image quality of the solid portion in a conventional image forming method.

As described above, an embodiment of the present invention can closely transfer a color toner and a transparent toner onto a recording medium, and therefore can enhance fixability of the color toner regardless of the application amount of the color toner.

Note that the transparent toner has no influence or a very small influence if any on a color tone of a formed image.

1 Image Forming Method

An embodiment of the present invention based on the above concept relates to an image forming method including: a step of developing an electrostatic latent image with a toner to form a toner image; and a step of transferring the toner image onto a recording medium and irradiating the toner image with an actinic ray to fix the toner to the recording medium. In the present embodiment, in the fixing step, a plurality of types of toners including a color toner and a transparent toner are attached to the same area included in the recording medium.

1-1. Step of Forming Toner Image

In this step, a color toner and a transparent toner are used to form a toner image.

Formation of a toner image can be performed in a similar manner to formation of a normal toner image by an electrophotographic method except that a color toner and a transparent toner are used. For example, for formation of a toner image, it is only required to charge an electrophotographic photoreceptor, to form an electrostatic latent image on a surface of the charged electrophotographic photoreceptor, and to develop the electrostatic latent image with a toner.

The electrophotographic photoreceptor can be, for example, a drum-shaped photoreceptor containing a known organic photoreceptor.

It is only required to charge the electrophotographic photoreceptor by charging a surface of the electrophotographic photoreceptor with a contact or non-contact charging roller or the like.

In formation of the electrostatic latent image, it is only required to expose a surface of the charged electrophotographic photoreceptor to light with light emitting diodes (LED), semiconductor lasers (LD), and the like arranged in an array, and to distribute static charges into a shape according to an image to be formed.

In development of the electrostatic latent image, a color toner or a transparent toner is applied to a surface of the electrophotographic photoreceptor on which the electrostatic latent image has been formed, and a toner image of each color corresponding to the color of the applied toner is formed.

At this time, by controlling formation of the electrostatic latent image and application of the plurality of types of toners such that both the color toner and the transparent toner are applied to the same area included in a formed image, a toner image is formed. The area means a small area in which a predetermined color tone is to be exhibited by application of substantially the same amount of color toner in a formed image. However, in an area in which a color toner is sufficiently closely transferred onto a recording medium without applying a transparent toner as in a small area in which a solid image with a color toner is to be formed, only the color toner is applied, and the transparent toner does not have to be applied.

At this time, by changing the application amount of the transparent toner to the area according to the application amount of the color toner to the area, a toner image may be formed. For example, by changing the application amount of the transparent toner so as to make the application amount of the transparent toner smaller in an area in which the application amount of the color toner is larger, and to make the application amount of the transparent toner larger in an area in which the application amount of the color toner is smaller, a toner image can be formed. This makes it possible to equalize, in the fixing step, the total amount of the color toner and the transparent toner attached to a plurality of areas on the recording medium regardless of the density of an image formed in each of the areas (transfer amount of the color toner). Therefore, it is possible to make it difficult for the toner particles to have a variation in fixability between the areas when the respective areas are irradiated with almost the same amount of light energy.

At this time, the application amount of the transparent toner is preferably changed such that the total application amount of the color toner and the transparent toner is 1 g/m² or more, preferably 2 g/m² or more, and still more preferably 2.5 g/m² or more from a viewpoint of closely transferring the color toner onto the recording medium sufficiently via the transparent toner. An upper limit of the total application amount is not particularly limited, but is preferably 24 g/m² or less from a viewpoint of transmitting a sufficient amount of actinic rays to the recording medium side of a toner image (side closer to the recording medium in the thickness direction of the toner image).

Note that here, softening of a toner means that a toner irradiated with an actinic ray undergoes phase transition or that the elastic modulus of a toner is reduced by a temperature rise due to irradiation with an actinic ray.

The application amount of the transparent toner is preferably changed such that a difference in the total application amount of the color toner and the transparent toner among a plurality of areas included in a formed image is 0.5 g/m² or less from a viewpoint of suppressing unevenness of texture in the formed image. The difference among the plurality of areas can be taken as a difference in the application amount between an area in which the total application amount of the color toner and the transparent toner is the largest and an area in which the total application amount of the color toner and the transparent toner is the smallest among 10 areas having different application amounts of the color toner, arbitrarily selected from a formed image.

In development of the electrostatic latent image, for example, it is only required to mix toner particles with a carrier, to charge the toner particles by friction at this time, and to hold the charged toner particles on a surface of a rotating magnet roller. The toner particles held on the surface of the rotating magnet roller move to a surface of an electrophotographic photoreceptor by an electric attraction force, and a toner image having a shape corresponding to the shape of the electrostatic latent image is formed on the surface of the electrophotographic photoreceptor.

In development of the electrostatic latent image, it is only required to continuously perform development of the electrostatic latent image with the color toner such as yellow, cyan, magenta, or black, and development of the electrostatic latent image with the transparent toner (application to the electrostatic latent image). The order of development with each of the color toners and the transparent toner is not particularly limited, and development may be performed in any order. Note that when development with the transparent toner is performed last, in a toner image transferred onto the recording medium via an intermediate transfer body, the transparent toner is likely to be disposed closer to a surface side (side farther from the recording medium in the thickness direction of the toner image). At this time, a surface of a formed image is coated with the transparent toner, and the color toner is unlikely to be detached from the formed image. Therefore, durability of the image is more likely to be enhanced. Note that when a toner image is directly transferred from the electrophotographic photoreceptor onto the recording medium, a similar effect can be obtained by first performing development with the transparent toner.

In a case of using a 5-cycle type image forming method for sequentially applying the color toner and the transparent toner to one electrophotographic photoreceptor, by repeating formation and development of an electrostatic latent image on the electrophotographic photoreceptor, it is possible to form a toner image including the plurality of types of toners. In a case of using a tandem type image forming method for applying the color toner and the transparent toner to different electrophotographic photoreceptors, by performing formation and development of an electrostatic latent image on each of the electrophotographic photoreceptors independently, it is possible to form a plurality of toner images corresponding to the plurality of types of toners. In the present embodiment, in any of the methods, formation and development of an electrostatic latent image are performed such that both the color toner and the transparent toner are attached to the same area included in the recording medium when a toner image is transferred and fixed in a later step.

1-2. Step of Fixing Toner Image on Recording Medium

In this step, the formed toner image is transferred onto the recording medium and fixed thereto.

Fixing of a toner image can be performed in a similar manner to fixing of a normal toner image by an electrophotographic method except that the toner image is fixed to the recording medium such that the color toner and the transparent toner are attached to the same area included in the recording medium. For example, in fixing of a toner image, it is only required to soften toner particles constituting the toner image by irradiation with an actinic ray and to fuse the softened toner particles to the recording medium.

It is only required to transfer the toner image by a means such as corona discharge, a transfer belt, or a transfer roller. At this time, the toner image may be directly transferred from the electrophotographic photoreceptor onto the recording medium. Alternatively, after the toner image is primarily transferred onto the intermediate transfer body, the toner image may be secondarily transferred from the intermediate transfer body onto the recording medium.

In irradiation with the actinic ray, it is only required to irradiate the toner image with an actinic ray to soften toner particles constituting the toner image. Examples of the actinic ray include an ultraviolet ray (UV), an electron beam, an α ray, a γ ray, and an X-ray. For example, in irradiation with the actinic ray, it is only required to irradiate the toner image with the actinic ray by light emitting diodes (LED), semiconductor lasers (LD), and the like arranged in an array.

The actinic ray is preferably light (electromagnetic wave) having a wavelength of 280 nm or more and less than 480 nm. When the wavelength is 280 nm or more, destruction (cleavage) of a dye due to irradiation with an actinic ray is unlikely to occur, and a coloring property of a formed image is unlikely to decrease. When the wavelength is less than 480 nm, energy can be efficiently applied to toner particles. Therefore, fixability of the toner particles can be further enhanced. In particular, when the color toner or the transparent toner contains an ultraviolet absorber, the wavelength of less than 480 nm is preferable because the ultraviolet absorber sufficiently absorbs the light and can further enhance softening efficiency of the color toner or the transparent toner containing the ultraviolet absorber.

Moreover, the actinic ray is preferably so-called monochromatic radiation light having a small variation width from a specific frequency. For example, the actinic ray is preferably light having a wavelength range within 20 nm above and below a maximum emission wavelength of the actinic ray.

The irradiation amount of the actinic ray is preferably 0.1 J/cm² or more and 200 J/cm² or less, more preferably 0.5 J/cm² or more and 100 J/cm² or less, and still more preferably 1.0 J/cm² or more and 50 J/cm² or less.

Note that a toner image transferred onto a surface of the recording medium may be irradiated with the actinic ray, or a toner image before being transferred onto the surface of the recording medium may be irradiated with the actinic ray.

This step may include a step of pressing a toner image against the recording medium after irradiation with the actinic ray or simultaneously with irradiation with the actinic ray. By the pressing, air confined inside the toner image is pushed out to arrange the toner particles more densely, heat generated by irradiation with the actinic ray is more easily conducted between the toner particles, the toner particles are more easily softened, and fixability of the toner image can be further enhanced.

In the pressing, it is only required to cause the recording medium on which a toner image irradiated with the actinic ray is disposed to pass through a nip portion formed by two pressure rollers disposed at positions facing each other so as to sandwich the recording medium therebetween with respect to a conveyance path of the recording medium. Pressure applied to the toner image at this time is not particularly limited, but is preferably 0.01 MPa or more and 1.0 MPa or less, and more preferably 0.05 MPa or more and 0.8 MPa or less.

At this time, by heating either one of the two pressure rollers, softening of toner particles constituting the toner image can be promoted by heat, and fixability of the toner image can be further enhanced. At this time, it is preferable to heat only a pressure roller not in contact with the toner image and disposed on a lower surface side of the recording medium from a viewpoint of suppressing deformation of the toner image due to heat. At this time, a surface of the toner image is preferably heated to a temperature higher by 20° C. or more and 100° C. or less than Tg of toner particles having the lowest glass transition temperature (Tg) measured by a differential scanning calorimeter such as DSC 8500 manufactured by Perkin Elmer among a plurality of types of toner particles contained in the toner image from a viewpoint of suppressing hot offset (transfer to the pressure rollers) of the toner particles softened by heat while further enhancing fixability of the toner image.

1-3. Other Steps

Note that after these steps, toner particles which have not been transferred and remain on surfaces of the electrophotographic photoreceptor, the intermediate transfer body, and the like may be removed. The removal can be performed by rubbing the surfaces of the electrophotographic photoreceptor, the intermediate transfer body, and the like with a blade.

1-4. Color Toner and Transparent Toner

As the color toner and the transparent toner, known toners which are softened by irradiation with an actinic ray can be used.

Each of the color toner and the transparent toner may be a one-component magnetic toner in which toner particles contain a magnetic material, a two-component magnetic toner in which toner particles and a carrier formed of magnetic particles are mixed, or a nonmagnetic toner containing no magnetic material or carrier.

1-4-1. Composition of Toner Particles

The toner particles constituting each of the color toner and the transparent toner contain a binder resin, and an optionally added colorant, ultraviolet absorber, light phase transfer agent, release agent, charge control agent, and external additive.

As the binder resin, a resin known as a binder resin constituting toner particles can be used. Examples of the binder resin include a styrene resin, an acrylic resin, a styrene-acrylic resin, a polyester resin, a silicone resin, an olefin resin, an amide resin, and an epoxy resin. The toner particles may contain only one type or a plurality of types of the binder resins. Each of these binder resins may have a single layer, or the same or different types of binder resins may form a core-shell structure.

Among these binder resins, a styrene resin, an acrylic resin, a styrene-acrylic resin, and a polyester resin are preferable, and a styrene-acrylic resin and a polyester resin are more preferable because of tending to decrease viscosity by heating and having a high sharp melt property.

The glass transition temperature (Tg) of the binder resin, measured by a differential scanning calorimeter such as DSC 8500 manufactured by Perkin Elmer, is preferably 35° C. or higher and 70° C. or lower, and more preferably 35° C. or higher and 60° C. or lower from a viewpoint of further enhancing fixability while further enhancing heat resistance complementarity.

The colorant may be a dye or a pigment. The toner particles constituting the color toner only need to contain a colorant such as yellow, magenta, cyan, or black according to a color tone to be exhibited by the color toner. The toner particles constituting the transparent toner may contain a colorant to such an extent that a color tone to be exhibited by the color toner is not significantly changed by the transparent toner. However, preferably, the toner particles constituting the transparent toner substantially contain no colorant. The content of the colorant is preferably 0.1% by mass or less with respect to the total mass of toner particles constituting the transparent toner. The toner particles may contain only one type or a plurality of types of the colorants.

Examples of the yellow colorant include an yellow dye including C.I. Solvent Yellow 19, 44, 77, 79, 81, 82, 93, 98, 103, 104, 112, and 162, and an yellow pigment including C.I. Pigment Yellow 14, 17, 74, 93, 94, 138, 155, 180, and 185.

Examples of the magenta colorant include a magenta dye including C.I. Solvent Red 1, 49, 52, 58, 63, 111, and 122, and a magenta pigment including C.I. Pigment Red 5, 48:1, 53:1, 57:1, 122, 139, 144, 149, 166, 177, 178, and 222.

Examples of the cyan colorant include a cyan dye including C.I. Solvent Blue 25, 36, 60, 70, 93, and 95, and a cyan pigment including C.I. Pigment Blue 1, 7, 15, 15:3, 60, 62, 66, and 76.

Examples of the black colorant include a carbon black including channel black, furnace black, acetylene black, thermal black, and lamp black, a magnetic material including ferrite and magnetite, and an iron-titanium complex oxide.

The content of the colorant is preferably 0.5% by mass or more and 20% by mass or less, and more preferably 2% by mass or more and 10% by mass or less with respect to the total mass of the toner particles.

The ultraviolet absorber is an additive that has an absorption wavelength in a wavelength range of 180 to 400 nm and is deactivated by nonradiative deactivation without a structural change such as isomerization from an excited state or bond cleavage at least in an environment of 0° C. or higher. The ultraviolet absorber may be a non-polymerized organic compound, an inorganic compound, an organic polymer, or the like, but is preferably a non-polymerized organic compound or an organic polymer, and more preferably a non-polymerized organic compound. Here, compounds used as a light stabilizer and an antioxidant are also ultraviolet absorbers as long as satisfying the above requirements.

The ultraviolet absorber preferably has a maximum absorption wavelength in a range of 180 to 400 nm.

Examples of the ultraviolet absorber include a benzophenone-based ultraviolet absorber, a benzotriazole-based ultraviolet absorber, a triazine-based ultraviolet absorber, a cyanoacrylate-based ultraviolet absorber, a salicylate-based ultraviolet absorber, a benzoate-based ultraviolet absorber, a diphenyl acrylate-based ultraviolet absorber, a benzoic acid-based ultraviolet absorber, a salicylic acid-based ultraviolet absorber, a cinnamic acid-based ultraviolet absorber, a dibenzoylmethane-based ultraviolet absorber, a β,β-diphenyl acrylate-based ultraviolet absorber, a benzylidene camphor-based ultraviolet absorber, a phenylbenzimidazole-based ultraviolet absorber, an anthranyl-based ultraviolet absorber, an imidazoline-based ultraviolet absorber, a benzalmalonate-based ultraviolet absorber, and a 4,4-diarylbutadiene-based ultraviolet absorber. Among these ultraviolet absorbers, a benzophenone-based ultraviolet absorber, a benzotriazole-based ultraviolet absorber, a triazine-based ultraviolet absorber, a cyanoacrylate-based ultraviolet absorber, and a dibenzoylmethane-based ultraviolet absorber are preferable. The toner particles may contain only one type or a plurality of types of the ultraviolet absorbers.

Examples of the benzophenone-based ultraviolet absorber include octabenzone, 2,4-hydroxybenzophenone, 2-hydroxy-4-methoxybenzophenone, 2,2′-dihydroxy-4,4′-dimethoxybenzophenone, and 2-hydroxy-4-n-octyloxybenzophenone.

Examples of the benzotriazole-based ultraviolet absorber include 2-(2p-cresol), 2-(2H-benzotriazol-2-yl)-4,6-bis(1-methyl-1-phenylethyl) phenol, 2-[5-chloro (2H)-benzotriazol-2-yl]-4-methyl-6-(tert-butyl) phenol, 2-(2H-benzotriazol-2-yl)-4,6-di-tert-pentylphenol, 2-(2H-benzotriazol-2-yl)-4-(1,1,3,3-tetramethylbutyl) phenol, a reaction product of methyl-3-[3-t-butyl-5-(2H-benzotriazol-2-yl)-4-hydroxyphenyl] propionate with polyethylene glycol (molecular weight: about 300), 2-(2H-benzotriazol-2-yl)-6-dodecyl-4-methylphenol, 2-(2-hydroxy-5-tert-butylphenyl)-2H-benzotriazole, 2-ethylhexyl-3-[3-tert-butyl-4-hydroxy-5-(5-chloro-2H-benzotriazol-2-yl) phenyl] propionate, 2-(2H-benzotriazol-2-yl)-4,6-bis(1-methyl-1-phenylethyl) phenol, and 2-(2H-benzotriazol-2-yl)-6-(1-methyl-1-phenylethyl)-4-(1,1,3,3-tetramethylbutyl) phenol.

Examples of the triazine-based ultraviolet absorber include 2-(4,6-bis(2,4-dimethylphenyl)-1,3,5-triazin-2-yl)-5-hydroxyphenyl, 2-(4,6-diphenyl-1,3,5-triazin-2-yl)-5-[(hexyl) oxy] phenol, 2-[4-[(2-hydroxy-3-dodecyloxypropyl) oxy]-2-hydroxyphenyl]-4,6-bis(2,4-dimethylphenyl)-1,3,5-triazine, 2-[4-[(2-hydroxy-3-(2′-ethyl) hexyl) oxy]-2-hydroxyphenyl]-4,6-bis(2,4-dimethylphenyl)-1,3,5-triazine, 2,4-bis(2-hydroxy-4-butyloxyphenyl)-6-(2,4-bis-butyloxyphenyl)-1,3,5-triazine, and 2-(2-hydroxy-4-[1-octyloxycarbonyloxy) phenyl)-4,6-bis(4-phenyl)-1,3,5-triazine.

Examples of the cyanoacrylate-based ultraviolet absorber include ethyl-2-cyano-3,3-diphenyl acrylate and 2′-ethylhexyl-2-cyano-3,3-diphenyl acrylate.

Examples of the dibenzoylmethane-based ultraviolet absorber include 4-tert-butyl-4′-methoxydibenzoylmethane.

Examples of the inorganic ultraviolet absorber include titanium oxide, zinc oxide, cerium oxide, iron oxide, and barium sulfate. The particle diameter of the inorganic ultraviolet absorber is preferably 1 nm to 1 μm.

The content of the ultraviolet absorber is preferably 0.1% by mass or more and 50% by mass or less, and more preferably 0.5% by mass or more and 35% by mass or less with respect to the total mass of the toner particles. When the content of the ultraviolet absorber is 0.1% by mass or more, the ultraviolet absorber generates heat sufficiently by absorption of an ultraviolet ray, and the toner particles can be more suitably softened. When the content of the ultraviolet absorber is 50% by mass or less, the toner particles can contain a sufficient amount of binder resin. Therefore, a formed image is tougher, and fixability of the toner image is further enhanced.

The ultraviolet absorber may be contained in both the toner particles of the color toner and the toner particles of the transparent toner, but preferably contained at least in the toner particles of the transparent toner, having a small content of a colorant and likely to have a small absorption amount of an actinic ray.

The light phase transfer agent can be a known compound that undergoes phase transition by light irradiation to be softened and solidified and is contained in a toner used in an optical fixing method.

Examples of the light phase transfer agent include a known azobenzene derivative that undergoes cis-trans isomerization by light absorption, and a known hexaarylbisimidazole derivative in which a covalent bond is cleaved/recombined by light absorption. The toner particles may contain only one type or a plurality of types of the light phase transfer agents.

As the release agent, a known wax that can be contained in the toner particles as a release agent can be used.

Examples of the wax include an olefin-based wax including polyethylene, a low molecular weight polypropylene, and an oxidized low molecular weight polypropylene, a paraffin, and a synthetic ester wax. Among these waxes, a synthetic ester wax is preferable, and behenyl behenate, glycerin tribehenate, pentaerythritol tetrabehenate, and the like are more preferable because of having a constant melting point and low viscosity. The toner particles may contain only one type or a plurality of types of the waxes.

The content of the release agent is preferably 1% by mass or more and 30% by mass or less, and more preferably 3% by mass or more and 15% by mass or less with respect to the total amount of the toner particles.

The charge control agent only needs to be a known colorless compound that can apply a positive or negative charge to toner particles by triboelectric charging and can be contained as a charge control agent in the toner particles. The toner particles may contain only one type or a plurality of types of the charge control agents.

The content of the charge control agent is preferably 0.01% by mass or more and 30% by mass or less, and more preferably 0.1% by mass or more and 10% by mass or less with respect to the total mass of the toner particles.

The external additive can be a known fluidizing agent, cleaning agent, or the like to be added as a post-treatment agent to surfaces of toner particles in order to enhance flowability, chargeability, and cleaning performance of the color toner and the transparent toner.

Examples of the external additive include inorganic oxide particles including silica particles, alumina particles, and titanium oxide particles, inorganic stearic acid compound particles including aluminum stearate particles and zinc stearate particles, and inorganic titanic acid compound particles including strontium titanate particles and zinc titanate particles. Note that the external additives may be surface-treated with a silane coupling agent, a titanium coupling agent, a higher fatty acid, silicone oil, or the like in order to enhance heat-resistant storage stability and environmental stability. The toner particles may contain only one type or a plurality of types of the external additives.

The content of the external additive is preferably 0.05% by mass or more and 5% by mass or less, and more preferably 0.1% by mass or more and 3% by mass or less with respect to the total mass of the toner particles.

As each of the binder resin, the ultraviolet absorber, the light phase transfer agent, the release agent, the charge control agent, and the external additive, the toner particles constituting the color toner may contain the same compound as the toner particles constituting the transparent toner or may contain different compounds therefrom. The content of each of the binder resin, the light phase transfer agent, the ultraviolet absorber, the release agent, the charge control agent, and the external additive may be approximately the same or different between the toner particles constituting the color toner and the toner particles constituting the transparent toner.

An average particle diameter of the toner particles constituting the color toner and the transparent toner is preferably 4 μm or more and 10 μm or less, and more preferably 4 μm or more and 7 μm or less in terms of a volume-based median diameter (D50). When the average particle diameter is within the above range, transfer efficiency of a toner image is increased, image quality of halftone is improved, and image quality of thin lines, dots, and the like is improved.

The volume-based median diameter (D50) can be taken as a value measured and calculated using a measurement system obtained by connecting a computer equipped with Software V 3.51 which is data processing software manufactured by Beckman Coulter, Inc. to a Coulter Counter 3 which is a particle size distribution measuring apparatus manufactured by Beckman Coulter, Inc.

Specifically, 0.02 g of a measurement sample (color toner or transparent toner) is added to 20 mL of a surfactant solution (for example, a surfactant solution obtained by diluting a neutral detergent containing a surfactant component 10 times with pure water) and familiarized. Thereafter, the resulting solution is subjected to ultrasonic dispersion for one minute to prepare a dispersion of toner particles. This toner particle dispersion is injected into a beaker containing ISOTON II which is an electrolyte solution manufactured by Beckman Coulter Co., Ltd. using a pipette until the indicated concentration on a measuring apparatus is 8%. Thereafter, by setting the count number of measurement particles to 25000, setting an aperture diameter to 50 μm, and dividing a range of 1 to 30 μm as a measurement range into 256 parts, a frequency value is calculated, and a particle diameter of 50% from a larger volume integration fraction is derived. This particle diameter is taken as the volume-based median diameter (D50).

1-4-2. Method for Manufacturing Toner Particles

The toner particles constituting the color toner and the transparent toner can be manufactured in a similar manner to a known toner to be softened by irradiation with an actinic ray by a method such as an emulsion polymerization aggregation method or an emulsion aggregation method.

According to the emulsion polymerization aggregation method, a dispersion of particles of a binder resin obtained by an emulsion polymerization method is mixed with particles of an optionally added colorant, ultraviolet absorber, release agent, charge control agent, external additive, and the like. The particles are aggregated, associated, or fused until particles having desired particle diameters are obtained. Thereafter, an external additive is optionally added thereto to obtain toner particles.

According to the emulsion aggregation method, a dispersion of particles of a binder resin obtained by dropwise adding a solution in which the binder resin is dissolved to a poor solvent is mixed with particles of an optionally added colorant, ultraviolet absorber, release agent, charge control agent, external additive, and the like. The particles are aggregated, associated, or fused until particles having desired particle diameters are obtained. Thereafter, an external additive is optionally added thereto to obtain toner particles.

By simultaneously mixing the dispersion of particles of a colorant at the time of the mixing, it is possible to manufacture toner particles constituting the color toner. Meanwhile, by not simultaneously mixing the dispersion of particles of a colorant at the time of the mixing, it is possible to manufacture toner particles constituting the transparent toner.

Note that by further adding a polymerization initiator and a polymerizable monomer to the dispersion of particles of the binder resin and performing a polymerization treatment, toner particles each having a structure of two or more layers may be obtained. Alternatively, the particles of the binder resin each having a structure of two or more layers may be manufactured by an emulsion polymerization method, and a toner may be manufactured using the particles of the binder resin.

1-4-3. Career The carrier is mixed with the toner particles described above to form a two-component magnetic toner.

The carrier only needs to be formed of known magnetic particles that can be contained in a toner.

Examples of the magnetic particles include particles containing a magnetic material such as iron, steel, nickel, cobalt, ferrite, magnetite, or alloys of these with aluminum or lead. The carrier may be a coated carrier in which surfaces of particles formed of the magnetic material are coated with a resin or the like, or may be a resin dispersion type carrier in which the magnetic material is dispersed in a binder resin. Examples of the coating resin include an olefin resin, a styrene resin, a styrene-acrylic resin, a silicone resin, a polyester resin, and a fluorocarbon resin. Examples of the binder resin include an acrylic resin, a styrene-acrylic resin, a polyester resin, a fluorocarbon resin, and a phenol resin.

An average particle diameter of the carrier is preferably 20 μm or more and 100 μm or less, and more preferably 25 μm or more and 80 μm or less in terms of a volume-based median diameter (D50). The average particle diameter of the carrier can be measured, for example, with a laser diffraction type particle size distribution measuring apparatus HELOS equipped with a wet type dispersing machine and manufactured by SYMPATEC Gmbh.

The content of the carrier is preferably 2% by mass or more and 10% by mass or less with respect to the total mass of the toner particles and the carrier.

2. Image Forming Apparatus

Another embodiment of the present invention based on the above concept relates to an image forming apparatus including: a toner image former that develops an electrostatic latent image with a toner to form a toner image; and a fixing device that transfers the toner image onto a recording medium and irradiates the toner image with an actinic ray to fix the toner to the recording medium. In the present embodiment, the fixing device fixes a plurality of types of toners including a color toner and a transparent toner to the same area included in the recording medium.

The image forming apparatus may be a 5-cycle type image forming apparatus including five color developing devices for clear (transparent), yellow, magenta, cyan, and black, and one electrophotographic photoreceptor or may be a tandem type image forming apparatus including five color developing devices for clear, yellow, magenta, cyan, and black, and five electrophotographic photoreceptors disposed for the respective colors.

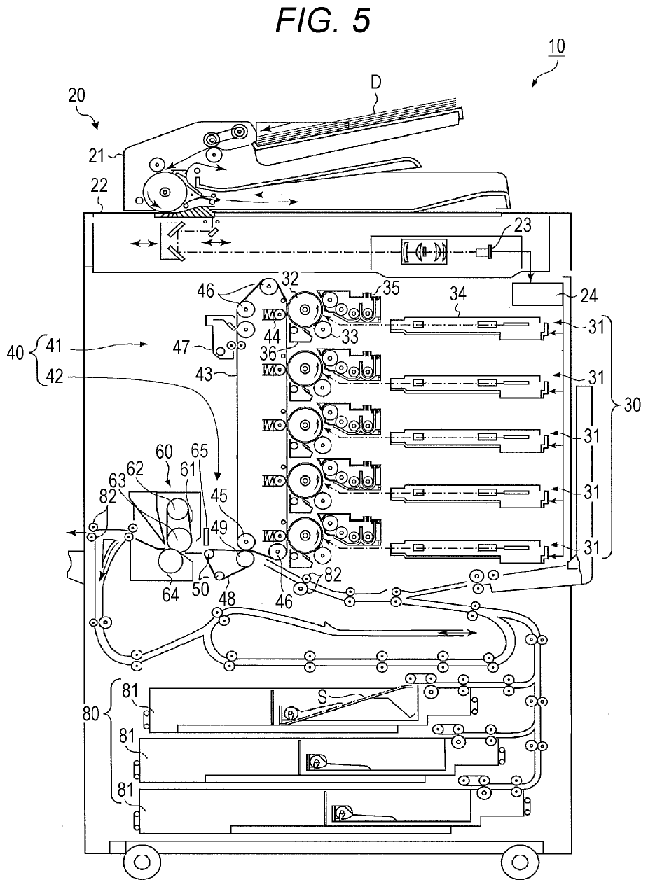

FIG. 5 is a schematic configuration view illustrating an example of an image forming apparatus 10 according to the present embodiment. The image forming apparatus 10 includes an image reader 20, a toner image former 30, an intermediate transferer 40 and a fixing device 60 constituting a fixing device, and a recording medium conveyer 80.

Incidentally, although not illustrated, the image forming apparatus 10 includes an arithmetic device such as a CPU unit including a central processing unit (CPU) and a random access memory (RAM) functioning also as controllers, a read only memory (ROM) functioning also as a storage unit, and the like, and a communication circuit.

The image reader 20 reads an image from the document D and obtains image data for forming an electrostatic latent image. The image reader 20 includes a sheet feeding device 21, a scanner 22, a CCD sensor 23, and an image processor 24.

The toner image former 30 includes five image forming units 31 corresponding to respective colors of clear, yellow, magenta, cyan, and black. Each of the image forming units 31 includes a photoreceptor (electrophotographic photoreceptor) 32, a charging device 33, an exposing device 34, a developing device 35, and a cleaning device 36.

The photoreceptor 32 is a negatively charged organic photoreceptor having photoconductivity. The photoreceptor 32 is charged by the charging device 33. The charging device 33 is a contact type charging device that brings a contact charging member such as a charging roller or a charging brush into contact with the photoreceptor 32 to charge the photoreceptor 32, and is, for example, a contact type charging device that performs contact charging with a charging roller.

The exposing device 34 irradiates the charged photoreceptor 32 with light to form an electrostatic latent image. The exposing device 34 is, for example, a semiconductor laser. The developing device 35 supplies a toner to the photoreceptor 32 on which the electrostatic latent image is formed, and attaches the toner in a shape corresponding to the electrostatic latent image. The developing device 35 is, for example, a known developing device in an electrophotographic image forming apparatus. The cleaning device 36 removes a residual toner on the photoreceptor 32. In this way, toner images corresponding to the respective toners are formed.

The intermediate transferer 40 includes a primary transfer unit 41 and a secondary transfer unit 42.

The primary transfer unit 41 includes an intermediate transfer belt 43, primary transfer rollers 44 disposed according to the respective image forming units 31, a backup roller 45, a plurality of first support rollers 46, and a cleaning device 47. The intermediate transfer belt 43 is an endless belt. The intermediate transfer belt 43 is stretched by the backup roller 45 and the first support roller 46. The intermediate transfer belt 43 travels at a constant speed in one direction on an endless track by rotational driving of at least one of the backup roller 45 and the first support roller 46.

The secondary transfer unit 42 includes a secondary transfer belt 48, a secondary transfer roller 49, and a plurality of second support rollers 50. The secondary transfer belt 48 is an endless belt. The secondary transfer belt 48 is stretched by the secondary transfer roller 49 and the second support roller 50.

From the respective image forming units 31, toner images of respective colors of clear, yellow, magenta, cyan, and black are primarily transferred onto the intermediate transfer belt 43, and the toner images are united. Thereafter, the united toner image is secondarily transferred from the intermediate transfer belt 43 onto a recording medium S traveling on the secondary transfer belt 48. In the secondarily transferred toner image, a plurality of types of toners including a color toner and a transparent toner is attached to the same area included in the recording medium S.

The fixing device 60 includes a fixing belt 61, a heating roller 62, a first pressure roller 63, a second pressure roller 64, a light irradiator 65, a heater, a temperature sensor, an air flow separation device, a guide plate, and a guide roller.

In the fixing belt 61, a base layer, an elastic layer, and a release layer are laminated in this order. The fixing belt 61 is axially supported by the heating roller 62 and the first pressure roller 63 in a state in which the base layer is on the inside and the release layer is on the outside.

The heating roller 62 has a rotatable aluminum sleeve and a heater disposed therein. The first pressure roller 63 has, for example, a rotatable core metal and an elastic layer disposed on an outer peripheral surface thereof.

The second pressure roller 64 is disposed so as to face the first pressure roller 63 via the fixing belt 61. The second pressure roller 64 is disposed so as to be able to approach and separate from the first pressure roller 63. When the second pressure roller 64 approaches the first pressure roller 63, the second pressure roller 64 presses the elastic layer of the first pressure roller 63 via the fixing belt 61 to form a fixing nip portion which is a contact portion with the fixing belt 61.

The first pressure roller 63 and the second pressure roller 64 heated by the heating roller 62 press a toner image in which a toner has been softened by irradiation with an actinic ray from the light irradiator 65 against the recording medium to further enhance fixability of the toner image.

The light irradiator 65 irradiates the toner image that has been secondarily transferred onto the recording medium S with an actinic ray. In the present embodiment, the light irradiator 65 irradiates the toner image with light having a wavelength of 280 nm or more and less than 480 nm. The irradiation amount at this time is 0.1 J/cm² or more and 200 J/cm² or less.

The air flow separation device is a device for generating an air flow from a downstream side in a moving direction of the fixing belt 61 to the fixing nip portion to promote separation of the recording medium S from the fixing belt 61.

The guide plate is a member for guiding the recording medium S having an unfixed toner image to the fixing nip portion. The guide roller is a member for guiding the recording medium to which the toner image has been fixed from the fixing nip portion to the outside of the image forming apparatus 10.

The recording medium conveyer 80 includes three sheet feeding tray units 81 and a plurality of resist roller pairs 82. The sheet feeding tray units 81 house the recording media (standard paper, special paper, and the like in the present embodiment) S identified based on basis weight, size, and the like according to the type set in advance. The resist roller pairs 82 are disposed so as to form a desired conveyance path.

Such an image forming apparatus 10 first irradiates the charged photoreceptor 32 with light to form an electrostatic latent image, and then supplies a toner to the photoreceptor 32 to form a toner image according to the electrostatic latent image. The toner image is transferred onto the recording medium S that has been sent by the recording medium conveyer 80 by the intermediate transferer 40. The recording medium S onto which the toner image has been transferred by the intermediate transferer 40 is fixed to the recording medium S by the fixing device 60. As a result, a plurality of types of toners including the color toner and the transparent toner is fixed to the same area included in the recording medium S. The recording medium to which the toner image has been fixed is guided out of the image forming apparatus 10 by the guide roller.

Each operation of the image forming apparatus 10 is controlled by the controller. In addition, the controller also acts as an application amount changer that changes the application amount of the transparent toner to each of areas included in a formed image from the toner image former 30 for a clear toner according to the amount of a color toner applied for the area.

For example, the controller may change the application amount of the transparent toner from the toner image former 30 for a clear toner such that the attachment amount of the transparent toner is smaller in an area in which the attachment amount of the color toner is larger, and the attachment amount of the transparent toner is larger in an area in which the attachment amount of the color toner is smaller.

In addition, the controller may change the application amount of the transparent toner from the toner image former 30 for a clear toner such that the total attachment amount of the color toner and the transparent toner is 1 g/m² or more, preferably 2 g/m² or more, and more preferably 2.5 g/m² or more. An upper limit of the total attachment amount is not particularly limited, but is preferably 24 g/m² or less. The application amount of the transparent toner can also be determined based on information regarding an image density.

In addition, the controller may change the application amount of the transparent toner from the toner image former 30 for a clear toner such that a difference in the total attachment amount of the color toner and the transparent toner among areas is 0.5 g/m² or less from a viewpoint of suppressing unevenness of texture in a formed image. The difference among the plurality of areas can be taken as a difference in the attachment amount between an area in which the total attachment amount of the color toner and the transparent toner is the largest and an area in which the total attachment amount of the color toner and the transparent toner is the smallest among 10 areas arbitrarily selected from a formed image and having different attachment amounts of the color toner. Note that the attachment amount is a value obtained by measuring the weights for the respective areas, subtracting the weight of the recording medium having the same area from each of the measured values, and averaging the resulting values.

3 Image-Formed Product

Another embodiment of the present invention based on the above concept relates to an image-formed product formed by fixing a color toner and a transparent toner to a recording medium, including a plurality of fixed products of the color toner united via a fixed product of the transparent toner.

As illustrated in FIGS. 3B and 4B, unification of the plurality of fixed products of the color toner via a fixed product of the transparent toner means that two or more fixed products of the color toner are in contact with a certain fixed product of the transparent toner. In other words, in the image-formed product, a fixed product (transparent resin) derived from a transparent toner and a fixed product (color resin) derived from a color toner are mixed. Note that the fixed product means a product fixed to a recording medium by deformation of toner particles constituting the toner so as to be in close contact with other toner particles by softening (and pressing).

The image-formed product may include a plurality of areas having different attachment amounts of fixed products of the color toner. At this time, both an area in which the attachment amount of fixed products of the color toner is larger (see FIG. 3B) and an area in which the attachment amount of fixed products of the color toner is smaller (see FIG. 4B) include a plurality of fixed products of the color toner united via a transparent toner.

The image-formed product preferably has a smaller attachment amount of fixed products of the transparent toner in an area in which the attachment amount of fixed products of the color toner is larger, and preferably has a larger attachment amount of fixed products of the transparent toner in an area in which the attachment amount of fixed products of the color toner is smaller.

In the image-formed product, the total attachment amount of fixed products of the color toner and fixed products of the transparent toner is preferably 1 g/m² or more, more preferably 2 g/m² or more, and still more preferably 2.5 g/m² or more. An upper limit of the total attachment amount is not particularly limited, but is preferably 24 g/m² or less.

In addition, the image-formed product preferably has a difference in the total attachment amount of fixed products of the color toner and fixed products of the transparent toner among areas is 0.5 g/m² or less from a viewpoint of suppressing unevenness of texture in a formed image. The difference among the plurality of areas can be taken as a difference in the attachment amount between an area in which the total attachment amount of fixed products of the color toner and fixed products of the transparent toner is the largest and an area in which the total attachment amount of fixed products of the color toner and fixed products of the transparent toner is the smallest among 10 areas arbitrarily selected from a formed image and having different attachment amounts of fixed products of the color toner.

Note that the image-formed product may include an area including no fixed product of the transparent toner, such as an area in which the attachment amount of fixed products of the color toner is sufficiently large.

### EXAMPLES

Hereinafter, an embodiment of the present invention will be described in more detail with reference to Examples, but is not limited thereto.

1. Preparation of Transparent Toner

1-1. Preparation of Toner Particles 1 of Transparent Toner

1-1-1. Preparation of Dispersion of Particles of Binder Resin

(First Stage Polymerization)

In a reaction container equipped with a stirrer, a temperature sensor, a cooling tube, and a nitrogen introducing device, a solution obtained by dissolving 8 parts by mass of sodium dodecylsulfate in 3000 parts by mass of deionized water was put. While the resulting mixture was stirred at a stirring speed of 230 rpm under a nitrogen stream, the internal temperature was raised to 80° C. After the temperature was raised, an initiator solution obtained by dissolving 10 parts by mass of potassium persulfate in 200 parts by mass of deionized water was added thereto, and the liquid temperature was again set to 80° C. A polymerizable monomer solution containing 480 parts by mass of styrene, 250 parts by mass of n-butyl acrylate, 68.0 parts by mass of methacrylic acid, and 16.0 parts by mass of n-octyl-3-mercaptopropionate was dropwise added thereto over one hour. Thereafter, polymerization was performed by heating and stirring the solution at 80° C. for two hours to prepare dispersion 1A containing particles of styrene-acrylic resin A.

(Second Stage Polymerization)

In a reaction container equipped with a stirrer, a temperature sensor, a cooling tube, and a nitrogen introducing device, a solution obtained by dissolving 7 parts by mass of polyoxyethylene (2) sodium dodecyl ether sulfate in 800 parts by mass of deionized water was put. The solution was heated to 98° C. Thereafter, a polymerizable monomer solution obtained by dissolving 260 parts by mass of the dispersion 1, 245 parts by mass of styrene, 120 parts by mass of n-butyl acrylate, 1.5 parts by mass of n-octyl-3-mercaptopropionate, and 67 parts by mass of paraffin wax (HNP-11 manufactured by Nippon Seiro Co., Ltd.) as a release agent at 90° C. was added thereto. The resulting solution was mixed and dispersed for one hour with a mechanical dispersing machine (CREARMIX manufactured by M Technique Co., Ltd. (“CREARMIX” is a registered trademark of M Technique Co., Ltd.) having a circulation path to prepare a dispersion containing emulsified particles (oil droplets).

Subsequently, an initiator solution obtained by dissolving 6 parts by mass of potassium persulfate in 200 parts by mass of deionized water was added to this dispersion. This system was heated and stirred at 82° C. for one hour to perform polymerization, thereby preparing dispersion 1B containing particles of styrene-acrylic resin B.

(Third Stage Polymerization)

An initiator solution obtained by dissolving 11 parts by mass of potassium persulfate in 400 parts by mass of deionized water was added to the dispersion 1B. Subsequently, a polymerizable monomer solution containing 435 parts by mass of styrene, 130 parts by mass of n-butyl acrylate, 33 parts by mass of methacrylic acid, and 8 parts by mass of n-octyl-3-mercaptopropionate was dropwise added thereto over one hour at a temperature of 82° C. After completion of the dropwise addition, the resulting solution was heated and stirred for two hours to perform polymerization, and then cooled to 28° C. to obtain dispersion 3 containing particles of styrene-acrylic resin C. The glass transition temperature (Tg) of styrene acrylic resin C was measured with a differential scanning calorimeter (DSC 8500 manufactured by Perkin Elmer) and found to be 45° C.

1-1-2. Preparation of Dispersion of Particles of Ultraviolet Absorber

80 parts by mass of dichloromethane and 20 parts by mass of 2-(2H-benzotriazol-2-yl)-4-(1,1,3,3-tetramethylbutyl) phenol (Adekastab LA-29 manufactured by ADEKA Corporation) as an ultraviolet absorber were mixed and stirred while being heated at 50° C. to obtain a solution containing benzotriazole. To 100 parts by mass of the obtained solution, a mixed solution of 99.5 parts by mass of distilled water warmed to 50° C. and 0.5 parts by mass of a 20% by mass sodium dodecylbenzene sulfonate aqueous solution was added. Thereafter, the resulting solution was stirred for 20 minutes with a homogenizer (manufactured by Heidolph) equipped with a shaft generator 18F at 16000 rpm and emulsified to obtain an emulsion of benzotriazole.

The resulting benzotriazole emulsion was put in a separable flask, and heated and stirred at 40° C. for 90 minutes while nitrogen was sent to a gas phase to remove an organic solvent, thereby obtaining a dispersion of particles of benzotriazole. The particle diameter of each of the particles of benzotriazole in the dispersion was measured with an electrophoretic light scattering photometer (ELS-800 manufactured by Otsuka Electronics Co., Ltd.), and found to be 183 nm in terms of a mass average particle diameter.

1-1-3. Preparation of Toner Particles

In a reaction container equipped with a stirrer, a temperature sensor, and a cooling tube, 684 parts by mass (in terms of solid content) of dispersion 3 containing the particles of styrene-acrylic resin C, 36 parts by mass (in terms of solid content) of the dispersion containing the particles of benzotriazole, and 900 parts by mass of deionized water were put. The pH was adjusted to 10 by adding a 5 mol/liter sodium hydroxide aqueous solution while the temperature in the container was maintained at 30° C.

Next, an aqueous solution obtained by dissolving 2 parts by mass of magnesium chloride hexahydrate in 1000 parts by mass of deionized water was dropwise added thereto over 10 minutes while being stirred. Thereafter, this system was heated to 70° C. over 60 minutes. While the temperature was maintained at 70° C., a particle growth reaction was continued. In this state, the particle diameters of associated particles were measured with a particle size distribution measuring apparatus (Multisizer 3 manufactured by Beckman Coulter, Inc.). When the volume-based median diameter (D50) reached 6.5 μm, an aqueous solution obtained by dissolving 190 parts by mass of sodium chloride in 760 parts by mass of deionized water was added thereto to stop particle growth. Thereafter, the solution was stirred at 70° C. for one hour, and then the temperature was further raised. The solution was heated and stirred at 75° C. to promote fusion of particles. Thereafter, by cooling the solution to 30° C., a dispersion of toner particles of a transparent toner was obtained.

The dispersion of toner particles obtained above was subjected to solid-liquid separation with a centrifuge to form a wet cake of the toner particles. The wet cake was washed with deionized water at 35° C. until the electric conductivity of a filtrate reached 5 μS/cm with the centrifuge, then transferred to a dryer (flash jet dryer manufactured by Seishin Enterprise Co., Ltd.), and dried until the water content reached 0.5% by mass to obtain powdery toner particles.

To the obtained powdery toner particles, 1% by mass of hydrophobic silica (number average primary particle diameter: 12 nm) and 0.3% by mass of hydrophobic titania (number average primary particle diameter: 20 nm) were added and mixed using a Henschel mixer (registered trademark) to prepare toner particles 1 of a transparent toner.

The volume based median diameter (D50) (average particle diameter of toner) of toner particles 1 of a transparent toner was measured using a measurement system obtained by connecting a computer equipped with Software V 3.51 which is data processing software manufactured by Beckman Coulter, Inc. to a Coulter Counter 3 which is a particle size distribution measuring apparatus manufactured by Beckman Coulter, Inc., and found to be 9.8 μm. The glass transition temperature (Tg) of transparent toner 1 was measured with a differential scanning calorimeter (DSC 8500 manufactured by Perkin Elmer) and found to be 44° C.

1-2. Preparation of Toner Particles 2 of Transparent Toner

80 parts by mass of dichloromethane and 20 parts by mass of 2,2′-dihydroxy-4,4′-dimethoxybenzophenone (Uvinul 3049 manufactured by BASF) as an ultraviolet absorber were mixed and stirred while being heated at 50° C. to obtain a solution containing benzophenone. To 100 parts by mass of the obtained solution, a mixed solution of 99.5 parts by mass of distilled water warmed to 50° C. and 0.5 parts by mass of a 20% by mass sodium dodecylbenzene sulfonate aqueous solution was added. Thereafter, the resulting solution was stirred for 20 minutes with a homogenizer (manufactured by Heidolph) equipped with a shaft generator 18F at 16000 rpm and emulsified to obtain an emulsion of benzophenone.

The resulting benzophenone emulsion was put in a separable flask, and heated and stirred at 40° C. for 90 minutes while nitrogen was sent to a gas phase to remove an organic solvent, thereby obtaining a dispersion of particles of benzophenone. The particle diameter of each of the particles of benzophenone in the dispersion of the particles of benzophenone was measured with an electrophoretic light scattering photometer (ELS-800 manufactured by Otsuka Electronics Co., Ltd.), and found to be 192 nm in terms of a mass average particle diameter.

Toner particles 2 of a transparent toner were manufactured in a similar manner to the preparation of toner particles 1 of a transparent toner described above except that the dispersion of the particles of benzophenone was used instead of the dispersion of the particles of benzotriazole.

The volume based median diameter (D50) (average particle diameter of toner) of toner particles 2 of a transparent toner was measured using a measurement system obtained by connecting a computer equipped with Software V 3.51 which is data processing software manufactured by Beckman Coulter, Inc. to a Coulter Counter 3 which is a particle size distribution measuring apparatus manufactured by Beckman Coulter, Inc., and found to be 7.5 μm. The glass transition temperature (Tg) of transparent toner 2 was measured with a differential scanning calorimeter (DSC 8500 manufactured by Perkin Elmer) and found to be 43° C.

1-3. Preparation of Toner Particles 3 of Transparent Toner

80 parts by mass of dichloromethane and 20 parts by mass of 4-tert-butyl-4′-methoxydibenzoylmethane (manufactured by Roche) as an ultraviolet absorber were mixed and stirred while being heated at 50° C. to obtain a solution containing dibenzoylmethane. To 100 parts by mass of the obtained solution, a mixed solution of 99.5 parts by mass of distilled water warmed to 50° C. and 0.5 parts by mass of a 20% by mass sodium dodecylbenzene sulfonate aqueous solution was added. Thereafter, the resulting solution was stirred for 20 minutes with a homogenizer (manufactured by Heidolph) equipped with a shaft generator 18F at 16000 rpm and emulsified to obtain an emulsion of dibenzoylmethane.

The resulting dibenzoylmethane emulsion was put in a separable flask, and heated and stirred at 40° C. for 90 minutes while nitrogen was sent to a gas phase to remove an organic solvent, thereby obtaining a dispersion of particles of dibenzoylmethane. The particle diameter of each of the particles of dibenzoylmethane in the dispersion of the particles of dibenzoylmethane was measured with an electrophoretic light scattering photometer (ELS-800 manufactured by Otsuka Electronics Co., Ltd.), and found to be 190 nm in terms of a mass average particle diameter.

Toner particles 3 of a transparent toner were manufactured in a similar manner to the preparation of toner particles 1 of a transparent toner described above except that the dispersion of the particles of dibenzoylmethane was used instead of the dispersion of the particles of benzotriazole.

The volume-based median diameter (D50) (average particle diameter of toner) of toner particles 3 of a transparent toner was measured using a measurement system obtained by connecting a computer equipped with Software V 3.51 which is data processing software manufactured by Beckman Coulter, Inc. to a Coulter Counter 3 which is a particle size distribution measuring apparatus manufactured by Beckman Coulter, Inc., and found to be 7.1 μm. The glass transition temperature (Tg) of transparent toner 3 was measured with a differential scanning calorimeter (DSC 8500 manufactured by Perkin Elmer) and found to be 46° C.

A ferrite carrier having a volume average particle diameter of 30 μm was prepared by coating ferrite with a copolymer resin of cyclohexane methacrylate and methyl methacrylate (monomer mass ratio 1:1). The toner particles 1, the toner particles 2, and the toner particles 3 of the transparent toner, and an upper ferrite carrier were mixed for 30 minutes using a V-type mixer at such a ratio such that the concentration of the toner particles was 6% by mass to manufacture transparent toner 1, transparent toner 2, and transparent toner 3 were manufactured, respectively.

2. Preparation of Color Toner

2-1. Preparation of Black Toner

To a solution obtained by dissolving 11.5 parts by mass of sodium n-dodecyl sulfate in 1600 parts by mass of pure water, 25 parts by mass of carbon black (MOGAL L manufactured by Cabot Corporation) was gradually added. Subsequently, carbon black was dispersed using a dispersing machine (CREARMIX CLM-0.8S manufactured by M Technique Co., Ltd. (“CREARMIX” is a registered trademark of M Technique Co., Ltd.)) to prepare a dispersion of carbon black. The particle diameter of each of particles of carbon black in the dispersion was measured with an electrophoretic light scattering photometer (ELS-800 manufactured by Otsuka Electronics Co., Ltd.), and found to be 118 nm in terms of a number-based median diameter.

A black toner was obtained in a similar manner to the above-described preparation of transparent toner 1 except that in a reaction container equipped with a stirrer, a temperature sensor, and a cooling tube, 504 parts by mass (in terms of solid content) of dispersion 3 containing the particles of styrene-acrylic resin C, 70 parts by mass (in terms of solid content) of the dispersion containing carbon black, and 900 parts by mass of deionized water were put, and the pH was adjusted to 10 by adding a 5 mol/liter sodium hydroxide aqueous solution while the temperature in the container was maintained at 30° C.

Note that the volume based median diameter (D50) (average particle diameter of toner) of toner particles of the black toner was measured using a measurement system obtained by connecting a computer equipped with Software V 3.51 which is data processing software manufactured by Beckman Coulter, Inc. to a Coulter Counter 3 which is a particle size distribution measuring apparatus manufactured by Beckman Coulter, Inc., and found to be 6.9 μm. The glass transition temperature (Tg) of transparent toner 3 was measured with a differential scanning calorimeter (DSC 8500 manufactured by Perkin Elmer) and found to be 47° C.

2-2. Preparation of Yellow Toner

A yellow toner was obtained in a similar manner to the preparation of the black toner except that C.I. Pigment Yellow 74 was used instead of carbon black.

Note that the volume-based median diameter (D50) (average particle diameter of toner) of toner particles of the yellow toner was measured using a measurement system obtained by connecting a computer equipped with Software V 3.51 which is data processing software manufactured by Beckman Coulter, Inc. to a Coulter Counter 3 which is a particle size distribution measuring apparatus manufactured by Beckman Coulter, Inc., and found to be 7.2 μm. The glass transition temperature (Tg) of transparent toner 3 was measured with a differential scanning calorimeter (DSC 8500 manufactured by Perkin Elmer) and found to be 49° C.

2-3. Preparation of Magenta Toner

A magenta toner was obtained in a similar manner to the preparation of the black toner except that C.I. Pigment Red 122 was used instead of carbon black.

Note that the volume-based median diameter (D50) (average particle diameter of toner) of toner particles of the magenta toner was measured using a measurement system obtained by connecting a computer equipped with Software V 3.51 which is data processing software manufactured by Beckman Coulter, Inc. to a Coulter Counter 3 which is a particle size distribution measuring apparatus manufactured by Beckman Coulter, Inc., and found to be 7.3 μm. The glass transition temperature (Tg) of transparent toner 3 was measured with a differential scanning calorimeter (DSC 8500 manufactured by Perkin Elmer) and found to be 47° C.

2-4. Preparation of Cyan Toner

A cyan toner was obtained in a similar manner to the preparation of the black toner except that C.I. Pigment Blue 15:3 was used instead of carbon black.

Note that the volume based median diameter (D50) (average particle diameter of toner) of toner particles of the cyan toner was measured using a measurement system obtained by connecting a computer equipped with Software V 3.51 which is data processing software manufactured by Beckman Coulter, Inc. to a Coulter Counter 3 which is a particle size distribution measuring apparatus manufactured by Beckman Coulter, Inc., and found to be 7.5 μm. The glass transition temperature (Tg) of transparent toner 3 was measured with a differential scanning calorimeter (DSC 8500 manufactured by Perkin Elmer) and found to be 48° C.

3. Fixability Test

An image was formed under normal temperature and normal humidity environment (temperature 20° C., humidity 50% RH) using the above transparent toner and color toner. Specifically, between a pair of parallel flat plate (aluminum) electrodes having a transparent toner or a color toner on one side thereof and having plain paper (basis weight: 64 g/m²) which is a recording medium on the other side thereof, the toner was caused to slide by a magnetic force. A gap between the electrodes was set to 0.5 mm. By adjusting DC bias and AC bias such that the attachment amount of each of the toners was as described in Table 1, the toner was developed, and a toner image was attached to a surface of the paper.

Thereafter, the toner image was fixed to the recording medium using a fixing device having the configuration illustrated in FIG. 5 to obtain a solid image. The toner image on the recording medium was irradiated with an ultraviolet ray having a wavelength of 385 nm under a condition that the irradiation amount was 2 J/cm² using an LED light source having an emission wavelength of 385 nm±10 nm as an irradiator.

The obtained image was cut into a 1 cm square and rubbed under pressure of 15 kPa ten times with JK wiper manufactured by Nippon Paper Cresia Co., Ltd. (“JK wiper” is a registered trademark of Nippon Paper Cresia Co., Ltd.). The image was evaluated with a fixing ratio. A fixing ratio of 70% or higher was regarded as being acceptable.

Note that the fixing ratio of an image is a numerical value obtained by measuring the density of an image immediately after formation and the density of the image after rubbing with a fluorescence spectrophotometer (FD-7 manufactured by Konica Minolta Inc.), dividing the reflective density of the solid image after rubbing by the reflective density of the solid image immediately after formation, and expressing the resulting value as a percentage.

Table 1 illustrates the types and attachment amounts of color toners and transparent toners used for image formation, and the fixing ratios of the respective images. Note that images were formed using a plurality of types of color toners in tests 9 and 10.

Note that an image was formed by setting the irradiation amount of the ultraviolet ray to 210 J/cm² in test 13.

TABLE 1

| | Image forming condition | | | | |
|---|---|---|---|---|---|
| | Color toner | | Transparent toner | | |
| | | Attach- | | Attach- | Evaluation |
| | | ment | | ment | result |
| | Type | amount | Type | amount | Fixing ratio |
| | [—] | [g/m²] | [—] | [g/m²] | [%] |
| Test 1 | Yellow | 1.0 | Transparent | 3.0 | 96 |
| | toner | | toner 1 | | |
| Test 2 | Yellow | 0.5 | Transparent | 3.5 | 98 |
| | toner | | toner 1 | | |
| Test 3 | Magenta | 1.0 | Transparent | 2.8 | 95 |
| | toner | | toner 1 | | |
| Test 4 | Magenta | 0.5 | Transparent | 3.2 | 97 |
| | toner | | toner 1 | | |
| Test 5 | Magenta | 0.5 | Transparent | 3.3 | 97 |
| | toner | | toner 2 | | |
| Test 6 | Magenta | 0.5 | Transparent | 3.2 | 96 |
| | toner | | toner 3 | | |
| Test 7 | Black | 0.5 | Transparent | 3.1 | 98 |
| | toner | | toner 1 | | |
| Test 8 | Black | 0.5 | Transparent | 0.9 | 79 |
| | toner | | toner 1 | | |
| Test 9 | Yellow | 0.25 | Transparent | 3.3 | 98 |
| | toner | | toner 1 | | |
| | Magenta | 0.25 | | | |
| | toner | | | | |
| Test 10 | Yellow | 0.15 | Transparent | 3.5 | 95 |
| | toner | | toner 1 | | |
| | Magenta | 0.15 | | | |
| | toner | | | | |
| | Cyan | 0.15 | | | |
| | toner | | | | |
| | Black | 0.15 | | | |
| | toner | | | | |
| Test 11 | Yellow | 0.5 | — | — | 3 |
| | toner | | | | |
| Test 12 | Magenta | 0.5 | — | — | 1 |
| | toner | | | | |
| Test 13 | Magenta | 4.2 | — | — | (Image |
| | toner | | | | unevenness |
| | | | | | NG) |

As illustrated in Table 1, by forming an image by combining a color toner and a transparent toner, the fixing ratio of the image was enhanced regardless of the attachment amount of the color toner.

Note that when the irradiation amount of an actinic ray was increased such that the fixing ratio of a color toner was enhanced even in an area in which the attachment amount was small using only a color toner, unevenness occurred in many portions of an image, and there was large variation in the reflection densities measured. Therefore, the fixing ratio could not be evaluated (test 13).

A solid image was formed under the conditions of test 1, and a difference in the attachment amount of a toner between areas was 0.3 g/m². The image had no unevenness in image density or texture visually. Meanwhile, the attachment amount of a transparent toner was intentionally adjusted in an output source image, and an image in which a difference in the toner attachment amount between areas was 1.0 g/m² was formed. As a result, unevenness of texture derived from glossiness was slightly observed although this unevenness was at a level having no problem for practical use.

According to an embodiment of the present invention, an image with less variation in image intensity can be formed by an electrophotographic image forming method regardless of the attachment ratio of a color toner.

Although embodiments of the present invention have been described and illustrated in detail, the disclosed embodiments are made for purposes of illustration and example only and not limitation. The scope of the present invention should be interpreted by terms of the appended claims

What is claimed is:

1. An image forming method comprising:
developing an electrostatic latent image with a toner to form a toner image; and
transferring the toner image onto a recording medium and irradiating the toner image with an actinic ray to fix the toner image to the recording medium, wherein
in the transferring, a plurality of types of toner particles containing toner particles of a color toner and toner particles of a transparent toner is fixed to the same area included in the recording medium.

2. The image forming method according to claim 1, wherein an application amount of the transparent toner to the area is changed according to an application amount of the color toner to the area.

3. The image forming method according to claim 1, wherein a total application amount of the color toner and the transparent toner to the area is 1 g/m² or more.

4. The image forming method according to claim 1, wherein in the transferring, the toner image that has been transferred onto the recording medium is irradiated with the actinic ray.

5. The image forming method according to claim 1, wherein the actinic ray has a wavelength of 280 nm or more and less than 480 nm.

6. The image forming method according to claim 1, wherein the toner particles of the transparent toner include an ultraviolet absorber.

7. An image forming apparatus comprising:
a toner image former that develops an electrostatic latent image with a toner to form a toner image; and
a fixing device that transfers the toner image onto a recording medium and irradiates the toner image with an actinic ray to fix the toner image to the recording medium, wherein
the fixing device fixes a plurality of types of toner particles containing toner particles of a color toner and toner particles of a transparent toner to the same area included in the recording medium.

8. The image forming apparatus according to claim 7, further comprising an application amount changer that changes an application amount of the transparent toner to the area according to an application amount of the color toner to the area.

9. The image forming apparatus according to claim 8, wherein the application amount changer changes the application amount of the transparent toner such that a total application amount of the color toner and the transparent toner is 1 g/m² or more.

10. A fixing device mounted on the image forming apparatus according to claim 7,
the fixing device comprising:
a transferer that transfers the toner image onto a recording medium; and
an irradiator that irradiates the toner image that has been transferred onto the recording medium with an actinic ray.

11. The fixing device according to claim 10, wherein the irradiator irradiates the toner image with light having a wavelength of 280 nm or more and less than 480 nm.

12. An image-formed product formed by fixing toner particles of a color toner and toner particles of a transparent toner to a recording medium,
the image-formed product comprising a plurality of fixed products of the color toner united via a fixed product of the transparent toner.

13. The image-formed product according to claim 12, further comprising
a plurality of areas having different attachment amounts of fixed products of the color toner, wherein
the plurality of areas has different attachment amounts of fixed products of the transparent toner according to the attachment amount of fixed products of the color toner.

14. The image-formed product according to claim 13, wherein a difference in a total attachment amount of fixed products of the color toner and fixed products of the transparent toner among the plurality of areas is 0.5 g/m² or less.
